(19) United States
(12) Patent Application Publication
(10) Pub. No.: US 2019/0053152 A1
(43) Pub. Date: Feb. 14, 2019

(54) Method for Determining the Appropriate Hello Packet Interval Based on the Network Conditions

(71) Applicant: GOVERNMENT OF THE UNITED STATES AS REPRESENTED BY THE SECRETARY OF THE AIR FORCE, ROME, NY (US)

(72) Inventors: ELIZABETH S. BENTLEY, CLINTON, NY (US); JOSEPH SUPRENANT, NEW HARTFORD, NY (US); STEPHEN REICHHART, WESTERNVILLE, NY (US)

(21) Appl. No.: 15/709,696

(22) Filed: Sep. 20, 2017

Related U.S. Application Data
(60) Provisional application No. 62/542,957, filed on Aug. 9, 2017.

(51) Int. Cl. H04W 52/02; H04W 40/20; H04W 40/24; H04W 40/26

(52) U.S. Cl. CPC H04W 52/0216; H04W 40/20; H04W 48/08; H04W 40/26; H04W 40/24

(57) ABSTRACT

A system, method and computer program product for determining an optimal hello packet interval in a radio communications network having a plurality of nodes is disclosed. At each reference node in the network a relative velocity is determined between that reference node and at least one other node within communication range of the reference node based upon a GPS location of the reference node and a GPS location of the at least one other node. A level of mobility within the network is then determined based upon the relative velocities between the reference nodes and the other nodes. The level of mobility is compared to a specific threshold and the hello packet interval may be optimally adjusted based upon the comparison of the level of mobility to the specific threshold.

### CROSS-REFERENCE TO RELATED APPLICATION

This non-provisional patent application claims the benefit of U.S. Provisional Application No. 62/542,957, filed Aug. 9, 2017.

### STATEMENT OF GOVERNMENT INTEREST

The invention described herein may be manufactured, used, and licensed by or for the Government of the United States for all governmental purposes without the payment of any royalty.

### BACKGROUND

Radio networks such as, for example, the Wireless Network after Next (WNaN) combine multiple spectrally agile transceivers, built from inexpensive commercially derived parts, that support dynamic spectrum access (DSA), dynamic frequency assignment (DFA), and disruption-tolerant networking (DTN). The WNaN network provides quality-of-service (QoS) differentiation and can sustain the throughput necessary to support a wide array of services. It was nominally designed for inexpensive warfighter-portable multi-hop radios but can also be easily extended to vehicular platforms.

If there is an advantaged node such as an Unmanned Aerial Vehicle (UAV) in the air, a significant amount of collisions can occur due to its advantaged location in the network topology. Since WNaN uses a variation of Carrier Sense Multiple Access/Collision Avoidance (CSMA/CA), nodes outside of Clear Channel Assessment (CCA) range experience the classic hidden terminal problem where two nodes that are out of range with each other want to transmit data to a third node. The two nodes may start to send packets to the third node at the same time, resulting in collisions. Traditionally, the method to avoid collisions consists of a request-to-send (RTS) and clear-to-send (CTS) packet handshake between a pair of sending and receiving nodes before transmitting data.

Other nodes that overhear RTS or CTS packets will hold off on their transmissions to avoid collisions. However, the application data like voice, video, or situational awareness information for a typical WNaN network is typically multicast traffic and is sent via broadcasting at the Medium Access Control (MAC) layer, making the use of RTS/CTS packets ineffective. By utilizing WNaN's multiple transceivers and dynamic frequency assignment algorithm, the number of collisions can be reduced, the average packet delivery ratio (PDR) can be increased, and the average packet delay can be decreased.

The ability to establish links and reliably exchange data can also be negatively impacted, if the advantaged node is a fast-moving node. Nodes periodically send hello packets to nodes within range for neighbor discovery and to maintain an updated network topology. The choice of the hello packet interval becomes crucial when mobility is involved. An interval that is chosen to be short is useful when the network contains nodes with high mobility, at the cost of an increase in control packet overhead and energy consumption. An interval that is chosen to be large saves energy and limits the overhead, at the risk of having an outdated network topology with dropped packets and broken links. The average PDR was increased with negligible changes to the average packet delay when the hello packet interval was adapted to the level of mobility in the WNaN network.

With node mobility, smaller hello packet intervals lead to higher throughput, at the cost of increased overhead. And, the impact of the hello packet intervals increases with increased node speed. Thus, by tuning the hello packet interval, the convergence time can be improved and the energy consumption reduced for the heterogeneous technologies routing without a major impact on network behavior.

### BRIEF DESCRIPTION OF THE DRAWINGS

The accompanying drawings provide visual representations which will be used to more fully describe various representative embodiments and can be used by those skilled in the art to better understand the representative embodiments disclosed and their inherent advantages. The drawings are not necessarily to scale, emphasis instead being placed upon illustrating the principles of the devices, systems, and methods described herein. In these drawings, like reference numerals may identify corresponding elements.

FIG. 1 is a diagram of a representative radio communications network having a plurality of nodes within communication range of a reference node in accordance with an embodiment of the present disclosure;

FIG. 2 is a block diagram of an architecture for a reference node communicating within the network of FIG. 1; and

FIG. 3 is a flow diagram of a method in accordance with an embodiment of the present disclosure for adjusting a hello packet interval based on network conditions.

### DETAILED DESCRIPTION

Specific embodiments of the disclosure will now be described in detail with reference to the accompanying figures. While this invention is susceptible of being embodied in many different forms, there is shown in the drawings and will herein be described in detail specific embodiments, with the understanding that the present disclosure is to be considered as an example of the principles of the invention and not intended to limit the invention to the specific embodiments shown and described. In the description below, like reference numerals may be used to describe the same, similar or corresponding parts in the several views of the drawings.

In this document, relational terms such as first and second, top and bottom, and the like may be used solely to distinguish one entity or action from another entity or action without necessarily requiring or implying any actual such relationship or order between such entities or actions. The terms “comprises,” “comprising,” “includes,” “including,” “has,” “having,” or any other variations thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

Reference throughout this document to “one embodiment,” “certain embodiments,” “an embodiment,” “implementation(s),” “aspect(s),” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means “any of the following: A; B; C; A and B; A and C; B and C; A, B and C.” An exception to this definition will occur only when a combination of elements, functions, steps or acts are in some way inherently mutually exclusive. Also, grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth.

All documents mentioned herein are hereby incorporated by reference in their entirety. References to items in the singular should be understood to include items in the plural, and vice versa, unless explicitly stated otherwise or clear from the text.

Recitation of ranges of values herein are not intended to be limiting, referring instead individually to any and all values falling within the range, unless otherwise indicated, and each separate value within such a range is incorporated into the specification as if it were individually recited herein. The words “about,” “approximately,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the described embodiments. The use of any and all examples, or exemplary language (“e.g.,” “such as,” or the like) provided herein, is intended merely to better illuminate the embodiments and does not pose a limitation on the scope of the embodiments. No language in the specification should be construed as indicating any unclaimed element as essential to the practice of the embodiments.

For simplicity and clarity of illustration, reference numerals may be repeated among the figures to indicate corresponding or analogous elements. Numerous details are set forth to provide an understanding of the embodiments described herein. The embodiments may be practiced without these details. In other instances, well-known methods, procedures, and components have not been described in detail to avoid obscuring the embodiments described. The description is not to be considered as limited to the scope of the embodiments described herein.

In the following description, it is understood that terms such as “first,” “second,” “top,” “bottom,” “up,” “down,” “above,” “below,” and the like, are words of convenience and are not to be construed as limiting terms. Also, the terms apparatus and device may be used interchangeably in this text.

In general, a methodology, system and a computer program product described herein in accordance with embodiments of the disclosure enables a hello packet interval to be adjusted to optimize network performance in terms of the average packet delivery ratio, particularly in cases where there are highly mobile nodes in the network. A short hello packet interval improves the performance of a network having highly mobile nodes. A long hello packet interval saves energy and limits the overhead. In networks where the topology is constantly changing, the present disclosure advantageously updates the hello packet interval periodically to account for such changes. The rate of change of the network topology is tied to the level of motion for all the nodes within the network, i.e. the average of the relative velocities across all nodes. If the network topology is changing frequently, the hello packet interval is kept short. If the network topology is static, the hello packet interval is set to the default level. The present disclosure enables measurement of the level of motion within a network to automatically determine whether the hello packet interval should be lowered or set to the default level.

The various methods, systems, apparatuses, and devices described herein apply generally to radio networks having highly mobile nodes, in which an advantaged node such as an Unmanned Aerial Vehicle (UAV) may cause a significant amount of collisions to occur due to its advantaged location in the network topology. In radio networks that use a variation of Carrier Sense Multiple Access/Collision Avoidance (CSMA/CA), nodes outside of Clear Channel Assessment (CCA) range experience the classic hidden terminal problem where two nodes that are out of range with each other want to transmit data to a third node. The two nodes may start to send packets to the third node at the same time, resulting in collisions. Traditionally, the method to avoid collisions consists of a request-to-send (RTS) and clear-to-send (CTS) packet handshake between a pair of sending and receiving nodes before transmitting data.

In accordance with one embodiment, there is provided a method of determining an optimal hello packet interval in a communications network having a plurality of nodes, at least one of which is a reference node. The method includes, for each reference node in the network, determining a relative velocity between the reference node and at least one other node within communication range of the reference node based upon a GPS location of the reference node and a GPS location of the at least one other node. A level of mobility within the network is determined based upon the relative velocity between the reference node and the at least one other node. The level of mobility is compared to a specific threshold, and the hello packet interval may be optimally adjusted based upon the comparison of the level of mobility to the specific threshold. Advantageously, the GPS location of a node may be injected into a corresponding hello packet.

In accordance with another embodiment, there is provided a system for determining an optimal hello packet interval in a communications network having a plurality of nodes and at least one reference node. Each reference node contains at least one processor executing computer program instructions stored in a non-transitory memory to cause the at least one processor to determine a relative velocity between that reference node and at least one other node within communication range of the reference node based upon a GPS location of the reference node and a GPS location of the at least one other node. A level of mobility within the network is determined based upon the relative velocities between the reference nodes and the other nodes. From this, the level of mobility is compared to a specific threshold and the hello packet interval may be optimally adjusted based upon the comparison of the level of mobility to the specific threshold.

In yet another embodiment, there is provided a computer program product consisting of a non-transitory computer usable storage medium storing computer usable program code for determining an optimal hello packet interval in a communications network. The computer program product includes computer usable program code, which when executed by at least one processor in at least one reference node in the network, causes the at least one processor to determine a relative velocity between the at least one reference node and at least one other node within communication range of the reference node based upon a GPS location of the reference node and a GPS location of the at least one other node. The computer usable program code, which when executed by the at least one processor, further causes the at least one processor to determine a level of mobility within the network based upon the relative velocity between the reference node and the at least one other node. The computer usable program code, which when executed by the at least one processor, then causes the at least one processor to compare the level of mobility to a specific threshold and adjust the hello packet interval based upon the comparison of the level of mobility to the specific threshold.

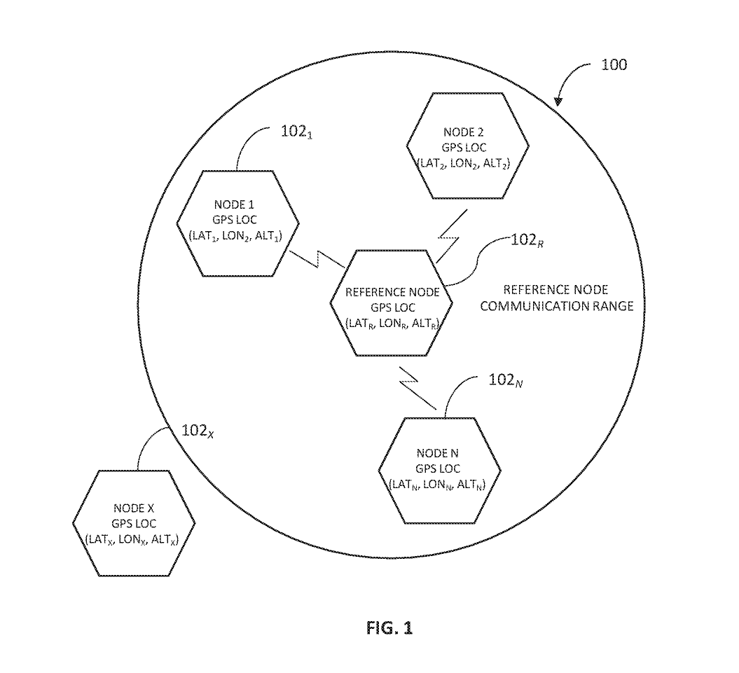

FIG. 1 is a diagram of a representative radio communications network 100 having a plurality of nodes 102₁, . . . , 102_{N} within communication range of a reference node 102_{R}. Node 102_{X} is outside of communication range from reference node 102_{R} in accordance with an embodiment of the present disclosure. Each of nodes 102₁, . . . , 102_{N} may serve as a reference node, but for purposes of illustration and clarity, a single reference node is shown in the drawing of FIG. 1. Further, as pictorially depicted each of nodes 102₁, . . . , 102_{N} and reference node 102_{R} has a corresponding GPS location in terms of LAT₁, LONG₁, ALT₁, . . . , LAT_{N}, LONG_{N}, ALT_{N} and LAT_{R}, LONG_{R}, ALT_{R}, respectively. The inventive methodology includes the collection of the GPS location, including the latitude, longitude, and altitude of all nodes within range in the network, the calculations of relative speeds of all nodes within range, and the calculation of the average relative speed across all nodes within range to provide a measure of the rate of change of the network topology. From this, a comparison is made with a user-defined velocity threshold to permit lowering of the hello packet interval if the relative velocity across all nodes are above the threshold or to reset the hello packet interval to the default value if the relative velocity is below the threshold. The process then waits for an update time interval before repeating the process. This is described in further detail below.

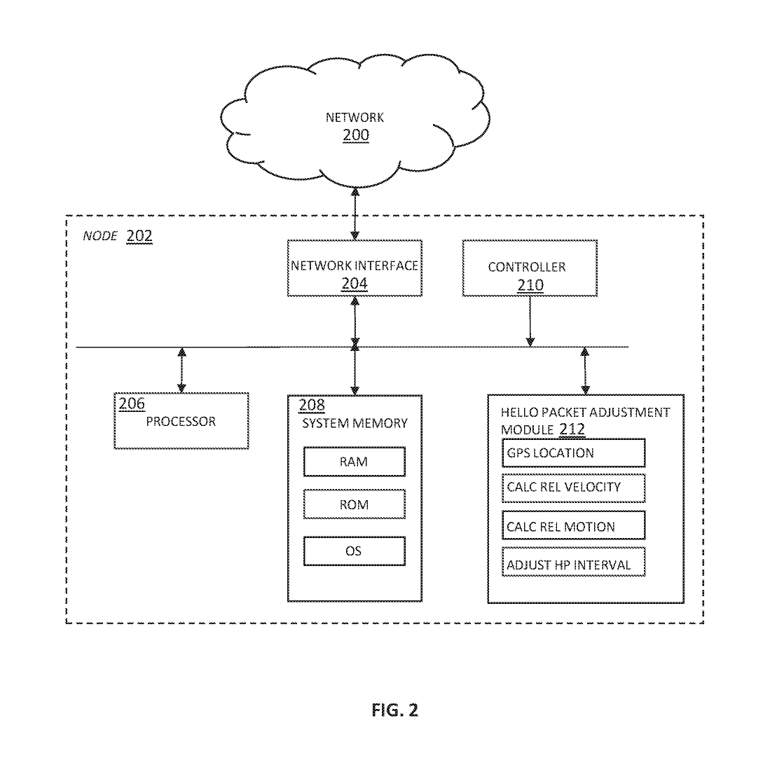

If the GPS locations are not already included in the hello packet format, a software module can be provided as depicted in the architecture of FIG. 2, whereby the GPS locations can be injected into the radio platform by including the GPS locations in the respective hello packets. Once the GPS locations are obtained, the relative velocities of all nodes within communication range (which is determined by the radio platform, power level, operating environment) are calculated in terms of the reference node 102_{R}. These calculations are advantageously repeated for each node 102_{R} acting as a reference node. The relative velocities are stored for previous time steps.

Referring now to FIG. 2, there is illustrated an architecture of an example node 202 communicating within network 200 in accordance with an embodiment of the present disclosure. Node 202 includes transceiver circuitry coupled to an antenna generally represented by network interface 204. The transceiver circuitry may include independent transmitter and receiver elements as known in the art. Node 202 further includes at least one processor 206, system memory 208 including random access memory (RAM), read only memory (ROM) and an operating system stored in persistent memory, an I/O controller 210. The network interface 204 is configured to couple to other nodes within communications network 200. The processor 206 may comprise one more microprocessors, co-processors, or the like, and is in communication with network interface 204 to enable radio communications with other nodes in network 200 as known in the art.

The network interface 204 may be configured to operate over a plurality of communication channels for simultaneous communication with other processors, servers, etc. The interface 204 is shown generally and, as known in the art, may include communications circuitry and an antenna coupled to a radio circuit with a transceiver for transmitting and receiving radio signals via the antenna. The radio circuit can be configured to operate in a mobile radio communications network such as, for example, a WNaN network, which is typically multicast traffic sent via broadcasting at the Medium Access Control (MAC) layer. It will be appreciated that the radio circuit may be configured to communicate in various radio networks, including networks utilizing global systems for mobile communications (GSM), code division multiple access (CDMA), wideband CDMA (WCDMA), time division multiple access (TDMA) and the like, as are conventionally known in the art of telecommunications.

In accordance with an embodiment of the present disclosure, the memory 208 includes computer program instructions containing computer usable program code embodied in a hello packet module 212. The code is executable by the at least one processor 206 to direct the node 202 to adjust the hello packet interval as described hereinafter.

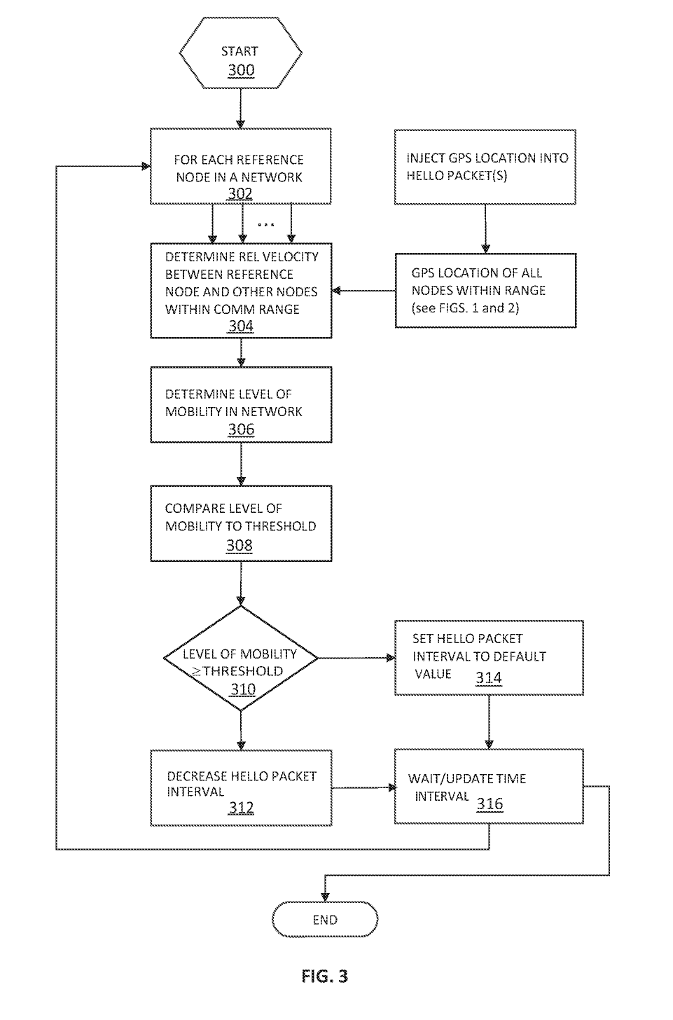

Referring now to FIG. 3, a flow diagram is illustrated for carrying out a method in accordance with an embodiment of the present disclosure. The process is initiated in block 300 with reference to FIG. 1 and nodes 102₁, . . . , 102_{N} within communication range of reference node 102_{R}. Block 302 identifies each reference node 102_{R} in network 100), where in block 304 a relative velocity is determined between reference node 102_{R} and each of nodes 102₁, . . . , 102_{N} within communication range thereof.

It will be appreciated by those skilled in the art that the determination in block 304 of the relative velocities between two nodes can be calculated by translating the GPS locations from Polar (latitude, longitude, altitude) to Cartesian coordinates (x, y, z):
Let Node 102₁ GPS coordinates=(LAT₁, LONG₁, ALT₁)
Let Node 102₂ GPS coordinates=(LAT₂, LONG₂, ALT₂)
Translate each point to Cartesian coordinates by applying these formulas
   R=6378137+alt (relative to center of the earth)
   x=R cos(lat)×sin(long)
   y=R sin(lat)
   z=R cos(lat)×cos(long)
This will give p₁=(x₁, y₁, z₁) and p₂=(x₂, y₂, z₂) points, respectively.
Use the Euclidian formula to find the distance between two points:

distance=\sqrt{(x₂−x₁)²+(y₂−y₁)²+(z−z₁)²}
Find the relative velocity:

$$◯ relative velocity = \frac{distance ( {t}_{2} ) - distance ( {t}_{1} )}{{t}_{2} - {t}_{1}}$$

In block 306, the level of mobility in the network is determined by averaging the relative velocities across all nodes. This provides a number that quantitatively represents the rate of change of the network topology. In block 308, the level of mobility is compared to a user-defined threshold that can be tuned as necessary to optimize performance.

In block 310, if the level of mobility is equal to or above the threshold, at block 312 the hello packet interval is decreased. If the determined level of mobility is below the threshold, block 314 sets the hello packet interval to the default value. Block 316 ensures that a user-defined time interval is maintained before repeating the process.

The above systems, devices, methods, processes, and the like may be realized in hardware, software, or any combination of these suitable for a particular application. The hardware may include a general-purpose computer and/or dedicated computing device. This includes realization in one or more microprocessors, microcontrollers, embedded microcontrollers, programmable digital signal processors or other programmable devices or processing circuitry, along with internal and/or external memory. This may also, or instead, include one or more application specific integrated circuits, programmable gate arrays, programmable array logic components, or any other device or devices that may be configured to process electronic signals. It will further be appreciated that a realization of the processes or devices described above may include computer-executable code created using a structured programming language such as C, an object oriented programming language such as C++, or any other high-level or low-level programming language (including assembly languages, hardware description languages, and database programming languages and technologies) that may be stored, compiled, or executed to run on one of the above devices, as well as heterogeneous combinations of processors, processor architectures, or combinations of different hardware and software. In another implementation, the methods may be embodied in systems that perform the steps thereof, and may be distributed across devices in a number of ways. At the same time, processing may be distributed across devices such as the various systems described above, or all of the functionality may be integrated into a dedicated, standalone device or other hardware. In another implementation, means for performing the steps associated with the processes described above may include any of the hardware and/or software described above. All such permutations and combinations are intended to fall within the scope of the present disclosure.

Embodiments disclosed herein may include computer program products comprising computer-executable code or computer-usable code that, when executing on one or more computing devices, performs any and/or all of the steps thereof. The code may be stored in a non-transitory fashion in a computer memory, which may be a memory from which the program executes (such as random-access memory associated with a processor), or a storage device such as a disk drive, flash memory or any other optical, electromagnetic, magnetic, infrared or other device or combination of devices. In another implementation, any of the systems and methods described above may be embodied in any suitable transmission or propagation medium carrying computer-executable code and/or any inputs or outputs from same.

It will be appreciated that the devices, systems, and methods described above are set forth by way of example and not of limitation. Absent an explicit indication to the contrary, the disclosed steps may be modified, supplemented, omitted, and/or re-ordered without departing from the scope of this disclosure. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context.

The method steps of the implementations described herein are intended to include any suitable method of causing such method steps to be performed, consistent with the patentability of the following claims, unless a different meaning is expressly provided or otherwise clear from the context. So, for example performing the step of X includes any suitable method for causing another party such as a remote user, a remote processing resource (e.g., a server or cloud computer) or a machine to perform the step of X. Similarly, performing steps X, Y, and Z may include any method of directing or controlling any combination of such other individuals or resources to perform steps X, Y, and Z to obtain the benefit of such steps. Thus, method steps of the implementations described herein are intended to include any suitable method of causing one or more other parties or entities to perform the steps, consistent with the patentability of the following claims, unless a different meaning is expressly provided or otherwise clear from the context. Such parties or entities need not be under the direction or control of any other party or entity, and need not be located within a particular jurisdiction.

It should further be appreciated that the methods above are provided by way of example. Absent an explicit indication to the contrary, the disclosed steps may be modified, supplemented, omitted, and/or re-ordered without departing from the scope of this disclosure.

It will be appreciated that the methods and systems described above are set forth by way of example and not of limitation. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context. Thus, while particular embodiments have been shown and described, it will be apparent to those skilled in the art that various changes and modifications in form and details may be made therein without departing from the scope of this disclosure and are intended to form a part of the disclosure as defined by the following claims, which are to be interpreted in the broadest sense allowable by law.

The various representative embodiments, which have been described in detail herein, have been presented by way of example and not by way of limitation. It will be understood by those skilled in the art that various changes may be made in the form and details of the described embodiments resulting in equivalent embodiments that remain within the scope of the appended claims.

What is claimed is:

1. A method of determining an optimal hello packet interval in a communications network having a plurality of nodes, at least one of which is a reference node, comprising:
at the reference node in the network:
determining a relative velocity between the reference node and at least one other node within communication range of the reference node based upon a GPS location of the reference node and a GPS location of the at least one other node;
determining a level of mobility within the network based upon the relative velocity between the reference node and the at least one other node;
comparing the level of mobility to a specific threshold; and
adjusting the hello packet interval based upon the comparison of the level of mobility to the specific threshold.

2. The method of determining an optimal hello packet interval in a communications network according to claim 1, further comprising a plurality of reference nodes and:
for each reference node in the network:
determining the relative velocity between the reference node and the at least one other node within communication range of the reference node based upon a GPS location of the reference node and a GPS location of the at least one other node;
determining the level of mobility within the network based upon the relative velocity between the reference node and the at least one other node;
comparing the level of mobility to a specific threshold; and
adjusting the hello packet interval based upon the comparison of the level of mobility to the specific threshold.

3. The method of determining an optimal hello packet interval in a communications network according to claim 1, further comprising injecting the GPS location of the node into a corresponding hello packet.

4. The method of determining an optimal hello packet interval in a communications network according to claim 1, where the hello packet interval is decreased when the level of mobility meets or exceeds the specific threshold.

5. The method of determining an optimal hello packet interval in a network according to claim 4, where the hello packet interval is set to default value when the level of mobility is below the specific threshold.

6. The method of determining an optimal hello packet interval in a communications network according to claim 2, further comprising storing the relative velocities for previous time steps.

7. The method of determining an optimal hello packet interval in a communications network according to claim 1, where the network is a radio network.

8. A system for determining an optimal hello packet interval in a communications network having a plurality of nodes and at least one reference node, comprising:
the at least one reference node comprising at least one processor executing computer program instructions stored in a non-transitory memory to cause the at least one processor to:
determine a relative velocity between the reference node and at least one other node within communication range of the reference node based upon a GPS location of the reference node and a GPS location of the at least one other node;
determine a level of mobility within the network based upon the relative velocity between the reference node and the at least one other node;
compare the level of mobility to a specific threshold; and
adjust the hello packet interval based upon the comparison of the level of mobility to the specific threshold.

9. The system for determining an optimal hello packet interval in a communications network according to claim 8, further comprising:
a plurality of reference nodes in the network, each reference node comprising at least one processor executing computer program instructions stored in a non-transitory memory to cause the at least one processor to:
determine a relative velocity between the reference node and at least one other node within communication range of the reference node based upon a GPS location of the reference node and a GPS location of the at least one other node;
determine a level of mobility within the network based upon the relative velocity between the reference node and the at least one other node;
compare the level of mobility to a specific threshold; and
adjust the hello packet interval based upon the comparison of the level of mobility to the specific threshold.

10. The system for determining an optimal hello packet interval in a communications network according to claim 8, further comprising computer program instructions, which when executed by the at least one processor, cause the at least one processor to inject the GPS location of the node into a corresponding hello packet.

11. The system for determining an optimal hello packet interval in a communications network according to claim 8, further comprising computer program instructions, which when executed by the at least one processor, cause the at least one processor to decrease the hello packet interval when the level of mobility meets or exceeds the specific threshold.

12. The system for determining an optimal hello packet interval in a communications network according to claim 11, further comprising computer program instructions, which when executed by the at least one processor, cause the at least one processor to set the hello packet interval to a default value when the level of mobility is below the specific threshold.

13. The system for determining an optimal hello packet interval in a communications network according to claim 9, further comprising computer program instructions, which when executed by the at least one processor, cause the at least one processor to store the relative velocities for previous time steps.

14. The system for determining an optimal hello packet interval in a communications network according to claim 8, where the network is a radio network.

15. A computer program product comprising a non-transitory computer usable storage medium storing computer usable program code for determining an optimal hello packet interval in a communications network, the computer program product comprising:
computer usable program code, which when executed by at least one processor in at least one reference node, causes the at least one processor to determine a relative velocity between the at least one reference node and at least one other node within communication range of the reference node based upon a GPS location of the reference node and a GPS location of the at least one other node;
computer usable program code, which when executed by the at least one processor, causes the at least one processor to determine a level of mobility within the network based upon the relative velocity between the reference node and the at least one other node;
computer usable program code, which when executed by the at least one processor, causes the at least one processor to compare the level of mobility to a specific threshold; and
computer usable program code, which when executed by the at least one processor, causes the at least one processor to adjust the hello packet interval based upon the comparison of the level of mobility to the specific threshold.

16. The computer program product according to claim 15, further comprising computer usable program code, which when executed by the at least one processor, causes the at least one processor to inject the GPS location of the node into a corresponding hello packet.

17. The computer program product according to claim 15, further comprising computer usable program code, which when executed by the at least one processor, causes the at least one processor to decrease the hello packet interval when the level of mobility meets or exceeds the specific threshold.

18. The computer program product according to claim 17, further comprising computer usable program code, which when executed by the at least one processor, causes the at least one processor to set the hello packet interval to a default value when the level of mobility is below the specific threshold.

19. The computer program product according to claim 15, further comprising computer usable program code, which when executed by the at least one processor, causes the at least one processor to store the relative velocities for previous time steps.

20. The computer program product according to claim 15, where the network is a radio network.
